(19) United States
(12) Patent Application Publication
(10) Pub. No.: US 2018/0059252 A1
(43) Pub. Date: Mar. 1, 2018

(54) INFORMATION PROCESSING METHOD, INFORMATION PROCESSING APPARATUS, AND COMPUTER READABLE STORAGE MEDIUM

(71) Applicant: FUJITSU LIMITED, Kawasaki-shi (JP)

(72) Inventor: Takashi MIURA, Kawasaki (JP)

(73) Assignee: FUJITSU LIMITED, Kawasaki-shi (JP)

(21) Appl. No.: 15/677,174

(22) Filed: Aug. 15, 2017

(30) Foreign Application Priority Data
Aug. 23, 2016 (JP) 2016-163056

(51) Int. Cl. G01S 19/42; G01C 21/30; G01S 19/22

(52) U.S. Cl. CPC G01S 19/42; G01S 19/28; G01S 19/22; G01C 21/30

(57) ABSTRACT

An information processing method including: acquiring data indicating a first location measured with a satellite positioning system including a plurality of satellites, identifying a second range corresponding to a first range including the first location based on first information and an arrangement pattern of the plurality of satellites at a time when the first location is measured, each of the first ranges being a range to which a location measured with the satellite positioning system corresponds, each of the second ranges being a range to which a corrected location obtained by correction processing to remove an error from the measured location corresponds, the first information indicating a correspondence relationship between each of the first ranges and each of the second ranges for each of arrangement patterns of the plurality of satellites, and identifying a second location by correcting the first location based on the identified second range.

### CROSS-REFERENCE TO RELATED APPLICATION

This application is based upon and claims the benefit of priority of the prior Japanese Patent Application No. 2016-163056, filed on Aug. 23, 2016, the entire contents of which are incorporated herein by reference.

### FIELD

The embodiments discussed herein are related to an information processing method, an information processing program, an information processing apparatus, and an information processing system.

### BACKGROUND

There is a conventional processing called map matching that identifies roads where a vehicle traveled, based on latitude and longitude data of the positions measured by a global positioning system (GPS) mounted on the vehicle. For analyzing road situations in various areas, there is a case where a large amount of latitude and longitude data of vehicles is aggregated to a server and map matching of the latitude and longitude data thus aggregated is collectively implemented by a batch processing.

For example, as a related art, there is a navigation system that sets a positioning error parameter indicating a positioning error range of present location information in each of predetermined areas of guidance route data based on environment information that varies over time. When the navigation system determines based on the positioning error parameter that at least a portion of the guidance route is present within a positioning error range around user's present location indicated by the present location information, the navigation system implements route navigation by outputting route navigation information.

Also, there is a technique that uses satellite information including accuracy information transmitted from multiple GPS satellites to calculate a reception point as a measured location, and estimates the present location from road information within a circular range around the calculated measured location having a radius of a GPS positioning error calculated from the accuracy information and three dimensional positioning accuracy drop rate. Also, there is a positioning system that calculates a vehicle's location from in-vehicle-side positioning coordinates acquired by an in-vehicle device and portable-side positioning coordinates acquired by a portable terminal device, based on in-vehicle-side positioning accuracy acquired by the in-vehicle device and portable-side positioning accuracy acquired by the portable terminal device.

Related techniques are disclosed in Japanese Laid-open Patent Publication Nos. 2011-145170, 6-148307, and 2009-121885.

### SUMMARY

According to an aspect of the invention, an information processing method includes acquiring data indicating a first location measured with a satellite positioning system including a plurality of satellites, identifying a second range corresponding to a first range including the first location based on first information and an arrangement pattern of the plurality of satellites at a time when the first location is measured, each of the first ranges being a range to which a location measured with the satellite positioning system corresponds, each of the second ranges being a range to which a corrected location obtained by correction processing to remove an error from the measured location corresponds, the first information indicating a correspondence relationship between each of the first ranges and each of the second ranges for each of arrangement patterns of the plurality of satellites, and identifying a second location by correcting the first location based on the identified second range.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram illustrating an example of an information processing method according to an embodiment;

FIG. 2 is an explanatory diagram illustrating a system configuration example of an information processing system;

FIG. 3 is a block diagram illustrating a hardware configuration example of the information processing apparatus;

FIG. 4 is a block diagram illustrating a hardware configuration example of a terminal device T;

FIG. 5 is an explanatory diagram illustrating an example of stored content of a pre-correction and post-correction location DB;

FIG. 6 is an explanatory diagram illustrating an example of stored content of a satellite arrangement pattern DB;

FIG. 7 is an explanatory diagram illustrating a specific example of an arrangement pattern P;

FIG. 8 is an explanatory diagram illustrating an example of stored content of a GPS error information map;

FIG. 9 is an explanatory diagram illustrating an example of stored content of an area table;

FIG. 10 is an explanatory diagram illustrating an example of stored content of a road data DB;

FIG. 11 is a block diagram illustrating a functional configuration example of the information processing apparatus;

FIG. 12 is an explanatory diagram illustrating an example of stored content of a satellite arrangement pattern table;

FIG. 13 is an explanatory diagram illustrating a specific example of a range search area;

FIG. 14 is an explanatory diagram illustrating a specific example of positioning data D;

FIG. 15 is an explanatory diagram illustrating an identification example of a road corresponding to a location indicated by the positioning data D;

FIG. 16 is an explanatory diagram illustrating a specific example of map matching data;

FIG. 17 is a flowchart illustrating an example of a pre-processing procedure of the information processing apparatus (Part 1);

FIG. 18 is a flowchart illustrating an example of a pre-processing procedure of the information processing apparatus (Part 2);

FIG. 19 is a flowchart illustrating an example of a real time processing procedure of the information processing apparatus (Part 1);

FIG. 20 is a flowchart illustrating an example of a real time processing procedure of the information processing apparatus (Part 2); and

FIG. 21 is a flowchart illustrating an example of a real time processing procedure of the information processing apparatus (Part 3).

### DESCRIPTION OF EMBODIMENTS

Positioning data measured by using a satellite positioning system such as GPS is usually corrected to remove an error there from. However, if the position data is corrected every time the position data is obtained, the conventional techniques have difficulty in implementing map matching in real time since the calculation for the error correction takes long time.

One aspect of the present disclosure is to implement map matching having a real time property and accuracy.

Hereinafter, embodiments of an information processing method, an information processing program, an information processing apparatus, and an information processing system according to the present disclosure are described in detail with reference to the accompanying drawings.

### EMBODIMENTS

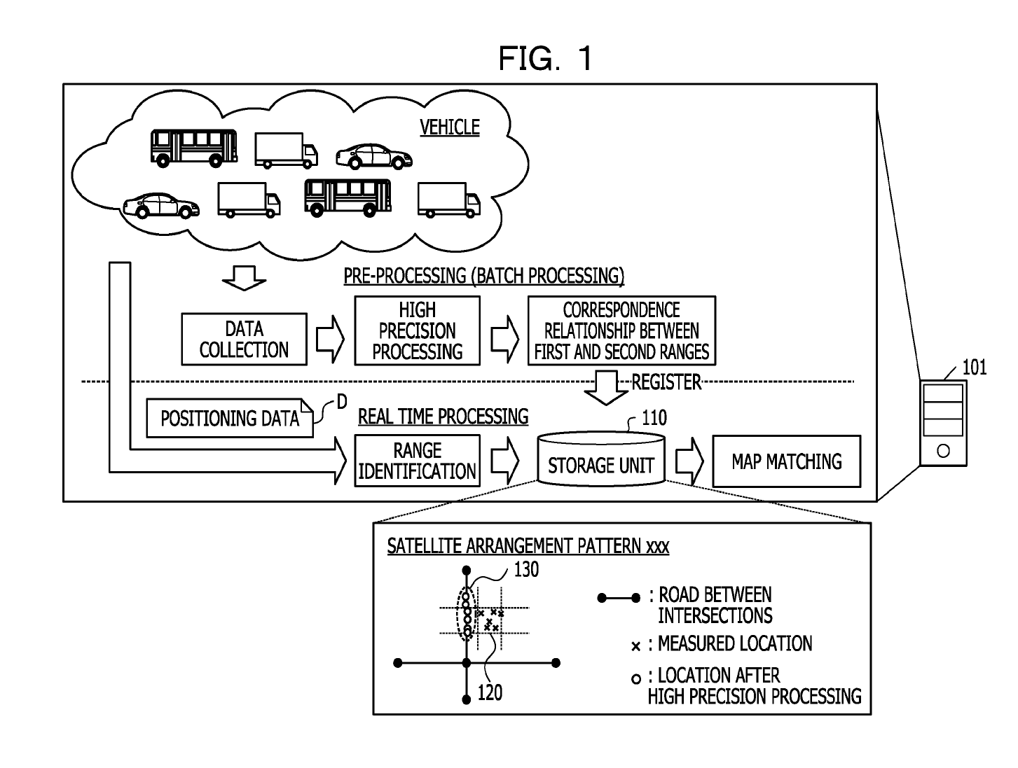

FIG. 1 is a diagram illustrating an example of an information processing method according to an embodiment. In FIG. 1, an information processing apparatus 101 is a computer configured to identify a road corresponding to a location measured with a satellite positioning system. The satellite positioning system is a system to measure a location by using radio waves (signals) from multiple satellites (positioning satellites). The satellite positioning systems include, for example, a GPS and a quasi-zenith satellite system.

One conceivable application of GPS sensors mounted on various vehicles traveling on roads is to aggregate positioning data acquired by the GPS sensors in a server and to provide traffic information reflecting real-time road situations in various areas identified by map matching of the aggregated positioning data. Map matching (MM) is a processing of identifying a road where a vehicle was traveling based on the positioning data of the GPS and so on.

However, an error (noise) may be contained in positioning data of the GPS sensor due to the locations of multiple satellites varying from moment to moment or influences of the multipath, the ionosphere, the troposphere, and so on. On the other hand, if positioning data is corrected to remove an error therefrom every time the positioning data is obtained, it is difficult to implement map matching having a real time property (immediacy) since calculation for error correction takes long time.

In view of the foregoing, this embodiment is described based on an information processing method of implementing map matching having a real time property and accuracy by performing similarity search based on information obtained by “pre-processing” by estimating, from a location indicated by positioning data, a range where an actual location (location after removal of an error) exists.

[Pre-Processing]

The information processing apparatus 101 obtains in advance a correspondence relationship between a first range and a second range for each of arrangement patterns of multiple satellites of a satellite positioning system. Here, the first range is a range where a location measured with the satellite positioning system exists. The second range is a range where a post-correction location exists which is obtained by correction processing that removes an error from the location measured with the satellite positioning system.

The arrangement patterns are classified based on a combination of the locations of multiple satellites that vary from moment to moment. The location of each of the satellites may be determined based on an angle range in which the satellite stays, the angle range being obtained by dividing the whole sky by a predetermined angle from the true north with a certain point (for example, Japan horizontal datum) as a reference. The location of each of the satellites also may be determined, for example, by considering the distance from the reference point to the satellite.

Specifically, for example, the information processing apparatus 101 collects, from GPS sensors mounted on various vehicles, positioning data indicating the locations of the vehicles measured with a satellite positioning system. The vehicles include, for example, an ordinary vehicle, a mini vehicle, a bus, a truck, a motorcycle, and so on. Next, the information processing apparatus 101 implements a correction processing (high precision processing) that removes an error from the location indicated by collected positioning data.

The error is, for example, an error due to the locations of multiple satellites varying from moment to moment or influences of the multipath, the ionosphere, the troposphere, and so on. More specifically, the post-correction location is a highly accurate location obtained by the correction processing in which an error due to influences of the multipath, the ionosphere, the troposphere, and so on is removed by considering a deviation of the error due to dilution of precision (DOP) depending on the locations of the multiple satellites.

Any existing method may be used as a method for removing an error from a location measured with the satellite positioning system.

Then, for each of the arrangement patterns of multiple satellites, the information processing apparatus 101 identifies the correspondence relationship between the first range and second range by a statistical method based on the location (measured location) measured with the satellite positioning system and the post-correction location and stores the correspondence relationship into a storage unit 110. In other words, the information processing apparatus 101 identifies the second range corresponding to the first range from a feature appearing based on the statistics.

More specifically, for example, for each of the arrangement patterns of the multiple satellites, the information processing apparatus 101 calculates a distribution of post-correction locations obtained by the correction processing on measured locations existing within the first range. Then, the information processing apparatus 101 may identify, as the second range, a distribution range of 3σ (σ: standard deviation) of the post-correction locations.

In the example illustrated in FIG. 1, a second range 130 corresponding to a first range 120 is indicated for an arrangement pattern xxx. The second range 130 is a distribution range 3σ of post-correction locations obtained by the correction processing (high precision MM processing) on measured locations existing within the first range 120.

Thus, for each of the arrangement patterns of the multiple satellites, an area where a post-correction location obtained from a measured location existing in the first range, that is, an actual location excluding the error is highly likely to exist may be registered as the second range in the storage unit 110.

[Real Time Processing]

The information processing apparatus 101 acquires positioning data D indicating a location measured with the satellite positioning system. Specifically, for example, the information processing apparatus 101 acquires the positioning data D indicating the location measured with the satellite positioning system from the GPS sensor mounted on the vehicle.

Next, the information processing apparatus 101 refers to the storage unit 110 and identifies the second range corresponding to the first range including a location indicated by the positioning data D based on the arrangement pattern of the multiple satellites at the time when the location indicated by the acquired positioning data D is measured.

Specifically, for example, the information processing apparatus 101 identifies the arrangement pattern of the multiple satellites at the time when the location indicated by the positioning data D is measured, based on the date and time (measurement time) when the location indicated by the positioning data D is measured. Then, the information processing apparatus 101 refers to the storage unit 110 and identifies the second range corresponding to the combination of the identified arrangement pattern and the first range including the location indicated by the positioning data D.

Here, the second range corresponding to the first range is an area where the post-correction location obtained by the correction processing (high precision processing) on the measured location existing within the first range is highly likely to exist. In other words, the second range may be said to be an area where an actual location of the measured location existing within the first range is highly likely to exist.

Then, the information processing apparatus 101 identifies a road corresponding to the location indicated by the positioning data D based on the identified second range. Specifically, for example, the information processing apparatus 101 identifies a road corresponding to the location indicated by the positioning data D by performing similarity search with the identified second range (map matching).

The similarity search is not a perfect key match search between values of a search target and a target to be searched, but a search for a value close to the search target among targets to be searched. As an example of the similarity search, a distance between a value of the target to be searched and a value of the search target is calculated by using a Eucrid distance, and a closest target to be searched is acquired.

Thus, the information processing apparatus 101 does not correct positioning data D every time the positioning data D is obtained, but estimates a range where an actual location (location after removal of an error) of a location indicated by the positioning data D may exist, and implements map matching by the similarity search using the estimated range. Thus, the map matching having a real time property and accuracy may be implemented.

(System Configuration Example of Information Processing System 200)

Next, a configuration example of an information processing system 200 according to the embodiment is described. In the description below, the GPS is used as an example of the satellite positioning system.

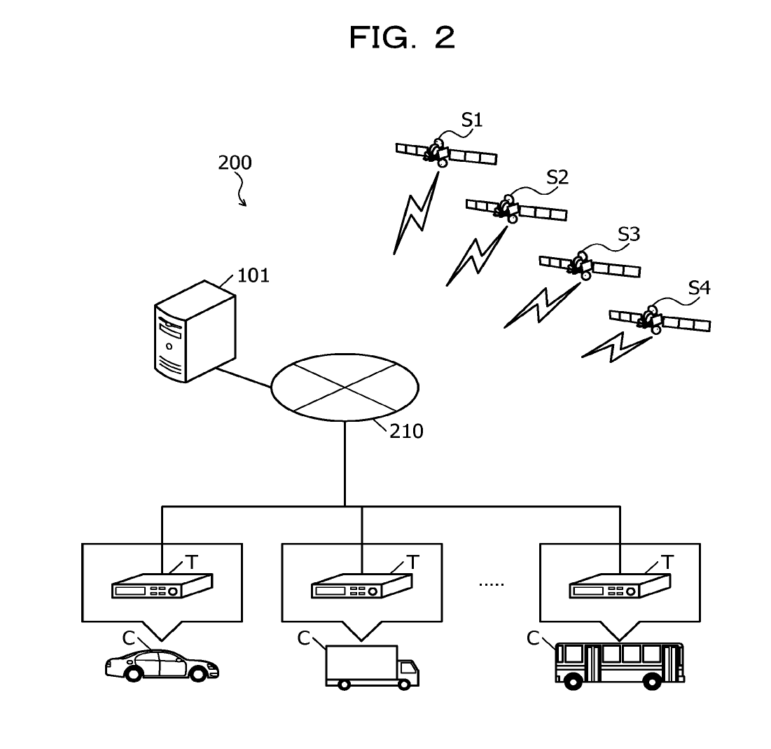

FIG. 2 is an explanatory diagram illustrating a system configuration example of the information processing system 200. In FIG. 2, the information processing system 200 includes an information processing apparatus 101 and multiple terminal devices T. In the information processing system 200, the information processing apparatus 101 and the multiple terminal devices T are coupled with each other via a wired or wireless network 210. The network 210 is, for example, internet, a mobile communication network, a local area network (LAN), a wide area network (WAN), and so on.

The information processing apparatus 101 identifies a road corresponding to a location of a vehicle C (terminal device T) measured with the GPS. The GPS is an example of the satellite positioning system configured to position the location by the radio wave from multiple satellites (for example, satellites S1 to S4). The vehicle C is an example of the mobile body such as, for example, an ordinary vehicle, a mini vehicle, a bus, a truck, and a motorcycle.

The terminal device T is a computer mounted on the vehicle C to position the location thereof (vehicle C) with the GPS including multiple satellites S (for example, satellites S1 to S4). Specifically, for example, the terminal device T transmits positioning data D indicating the location of the vehicle C measured at certain time intervals (for example, at intervals of 10 seconds) to the information processing apparatus 101 at regular intervals (for example, at intervals of 5 minutes).

The terminal device T may be applied to, for example, a digital tachograph. The terminal device T may be implemented by, for example, a car navigation system, a smartphone, a tablet personal computer (PC), and so on.

(Hardware Configuration Example of Information Processing Apparatus 101)

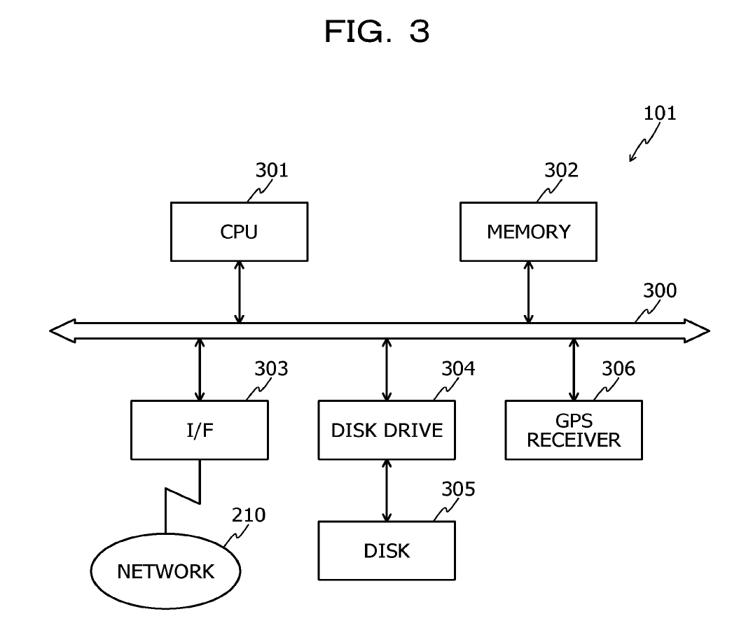

FIG. 3 is a block diagram illustrating a hardware configuration example of the information processing apparatus 101. In FIG. 3, the information processing apparatus 101 includes a central processing unit (CPU) 301, a memory 302, an interface (I/F) 303, a disk drive 304, a disk 305, and a GPS receiver 306. These components are coupled with each other via a bus 300.

Here, the CPU 301 controls entire information processing apparatus 101. The memory 302 includes, for example, a read only memory (ROM), a random access memory (RAM), and a flash ROM. Specifically, for example, the flash ROM and ROM store various programs, and the RAM is used as a work area of the CPU 301. When loaded into the CPU 301, a program stored in the memory 302 causes the CPU 301 to implement a coded processing.

The I/F 303 is coupled with the network 210 via a communication line, and coupled with an external computer (for example, terminal device T illustrated in FIG. 2) via the network 210. Then, the I/F 303 serves as an interface between the network 210 and internal components, and controls data input and output to and from an external computer. For example, a modem and a LAN adapter may be adopted as the I/F 303.

The disk drive 304 controls read/write of data into the disk 305 according to control of the CPU 301. The disk 305 stores data written by control of the disk drive 304. The disk 305 includes, for example, a magnetic disk, an optical disk, and so on.

The GPS receiver 306 receives the radio wave from satellites S (for example, satellites S1 to S4 illustrated in FIG. 2) of the GPS. The information processing apparatus 101 may include, for example, a solid state drive (SSD), an input device, a display, and so on, in addition to the above components.

(Hardware Configuration Example of Terminal Device T)

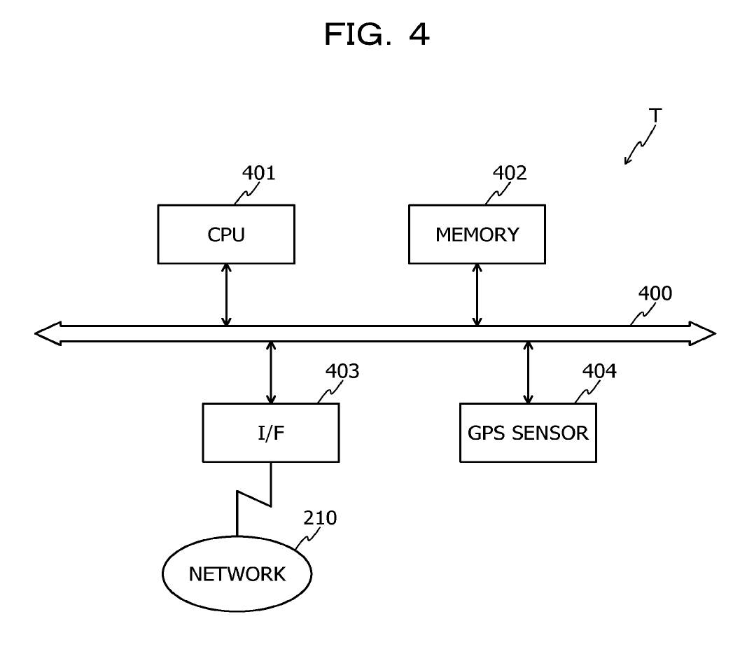

FIG. 4 is a block diagram illustrating a hardware configuration example of the terminal device T. In FIG. 4, the terminal device T includes a CPU 401, a memory 402, an I/F 403, and a GPS sensor 404. These components are coupled with each other via a bus 400.

Here, the CPU 401 controls entire terminal device T. The memory 402 includes, for example, a ROM, a RAM, a flash ROM, and so on. Specifically, for example, the flash ROM and ROM store various programs, and the RAM is used as a work area of the CPU 401. When loaded into the CPU 401, a program stored in the memory 402 causes the CPU 401 to implement a coded processing.

The I/F 403 is coupled with the network 210 via a communication line, and coupled with an external computer (for example, information processing apparatus 101) via the network 210. Then, the I/F 403 serves as an interface between the network 210 and internal components, and controls data input and output to and from an external computer.

The GPS sensor 404 receives the radio wave from satellites S (for example, satellites S1 to S4 illustrated in FIG. 2) of the GPS, and outputs positioning data indicating the location of the terminal device (vehicle C). The positioning data is, for example, information identifying one point on the earth in the longitude and latitude. The terminal device T may include, for example, a disk drive, a disk, a SSD, an input device, a display and so on, in addition to the above components.

(Stored Content of Various DBs)

Next, stored content of various data bases (DBs) of the information processing apparatus 101 is described. Various DBs are implemented, for example, by a storage device such as the memory 302 and disk 305 of the information processing apparatus 101 illustrated in FIG. 3.

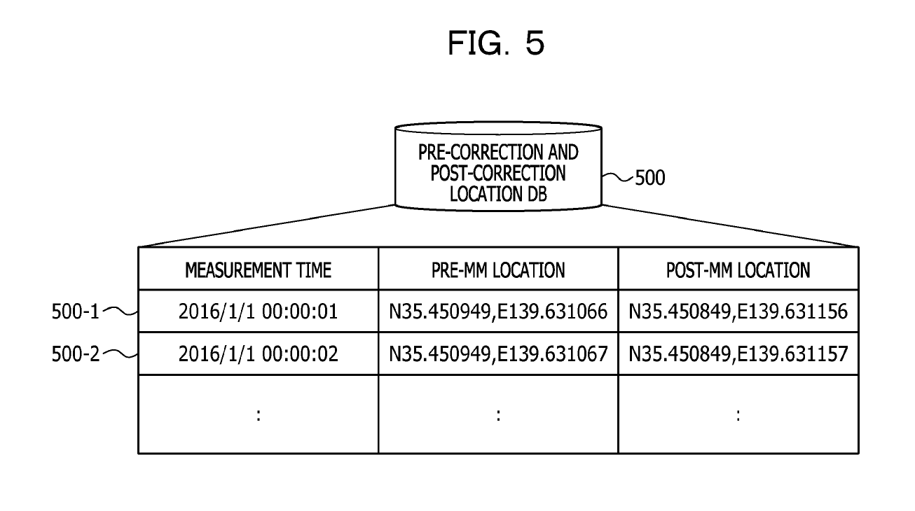

FIG. 5 is an explanatory diagram illustrating an example of stored content of a pre-correction and post-correction location DB 500. In FIG. 5, the pre-correction and post-correction location DB 500 includes fields of a measurement time, a pre-MM location, and a post-MM location, and stores pre-correction and post-correction location information (for example, pre-correction and post-correction location information 500-1, 500-2) as a record when information is set in these fields.

Here, the measurement time is a time when the pre-MM location is measured. The pre-MM location is latitude and longitude indicating the location of the vehicle C (terminal device T) measured with the GPS. The post-MM location is latitude and longitude indicating the location of the post-correction vehicle C (terminal device T) obtained by the correction processing for removing an error from the post-MM location.

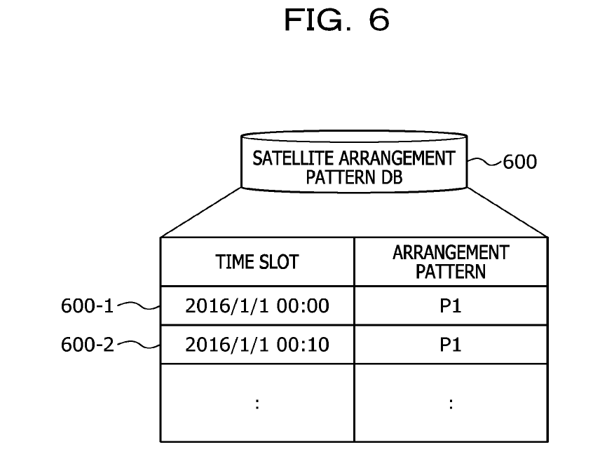

FIG. 6 is an explanatory diagram illustrating an example of stored content of a satellite arrangement pattern DB 600. In FIG. 6, the satellite arrangement pattern DB 600 includes fields of a time slot and an arrangement pattern, and stores satellite arrangement pattern history information (for example, satellite arrangement pattern history information 600-1, 600-2) as a record when information is set into these fields.

Here, the time slot is a time slot for each fixed time interval from a reference time. In the example of FIG. 6, the time slot is a time slot for every 10 minutes with 00 hour 00 minute of Jan. 1, 2016 as a reference time. For example, 00 hour 00 minute indicate 10 minutes between 00 hour 00 minute 00 second and 00 hour 09 minutes 59 seconds. The arrangement pattern is an arrangement pattern P classified based on the combination of the locations of the multiple satellites S for each of the time slots.

The satellite arrangement pattern DB 600 may identify a past arrangement pattern P indicating the positional relation among the multiple satellites in each of the past time slots. For example, it is obvious that the arrangement pattern P of the multiple satellites S for 10 minutes from 00 hour 00 minute of Jan. 1, 2016 is an “arrangement pattern P1”.

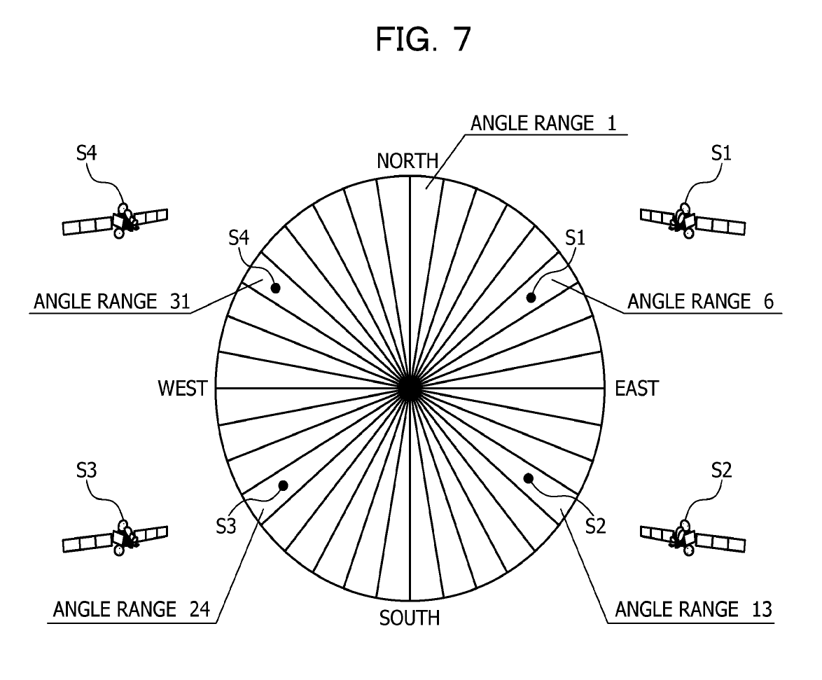

Here, a specific example of the arrangement pattern P is described with reference to FIG. 7. Here, the arrangement pattern P is described by using, as an example, a pattern classified based on the combination of the locations of four satellites S1 to S4 illustrated in FIG. 2.

FIG. 7 is an explanatory diagram illustrating a specific example of the arrangement pattern P. FIG. 7 indicates angle ranges obtained by dividing the entire sky for every 10 degrees from the true north with latitude and longitude origin of Japan (center point of a circle illustrated in FIG. 7) as a reference point. The locations of the satellites S1 to S4 is determined based on the angle range to which the satellite belongs, and a distance from the reference point. Each angle range is assigned with a number (1 to 36) in the clockwise order from the true north as a starting point.

For example, the arrangement pattern P of satellites S1 to S4 illustrated in FIG. 7 may be represented as below. A first parentheses “( )” in the bracket “[ ]” indicates an angle range to which each of satellites S1 to S4 belongs. A second parentheses “( )” in the bracket “[ ]” indicates a distance (unit: kilometer) from longitude/latitude origin of Japan to each of satellites S1 to S4. Individual satellites may not be identifiable.

Arrangement pattern P=[(6, 13, 24, 31), (20021, 20012, 21012, 21000)]

Thus, the arrangement pattern of satellites S1 to S4 may be classified based on the combination of the locations (angle range and distance) of the satellites S1 to S4. For example, angles with a deviation less than 10 degrees are regarded as the same angle. However, for the distance from the reference point, a deviation of several kilometers may be handled as the same distance.

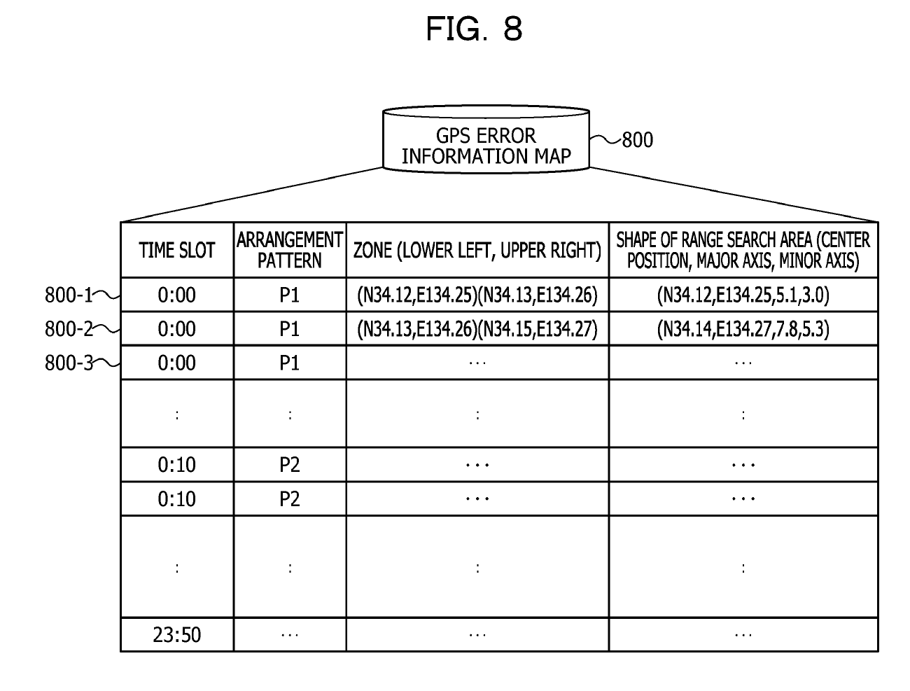

FIG. 8 is an explanatory diagram illustrating an example of stored content of a GPS error information map 800. In FIG. 8, the GPS error information map 800 includes fields of a time slot, an arrangement pattern, a zone, and a shape of a range search area, and stores GPS error information (for example, GPS error information 800-1 to 800-3) as a record when information is set into these fields.

Here, the time slot is a time slot for each fixed time interval from a reference time. In the example of FIG. 8, the time slot is a time slot for every 10 minutes with 00 hour 00 minute as a reference time. The arrangement pattern is an arrangement pattern P classified based on the combination of the locations of the multiple satellites S (for example, satellites S1 to S4) of the GPS for each of the time slots.

The zone indicates lower left coordinates (longitude and latitude) and upper right coordinates (longitude and latitude) of a rectangular area partitioned and divided on a map. The shape of the range search area is information identifying the shape of the range search area for each of the zones. Here, the shape of the range search area is information identifying the coordinates (longitude and latitude) of the center position of a rectangular range search area, and lengths (unit: meter) of the major axis and minor axis.

Stored content of the storage unit 110 illustrated in FIG. 1 corresponds to, for example, the GPS error information map 800.

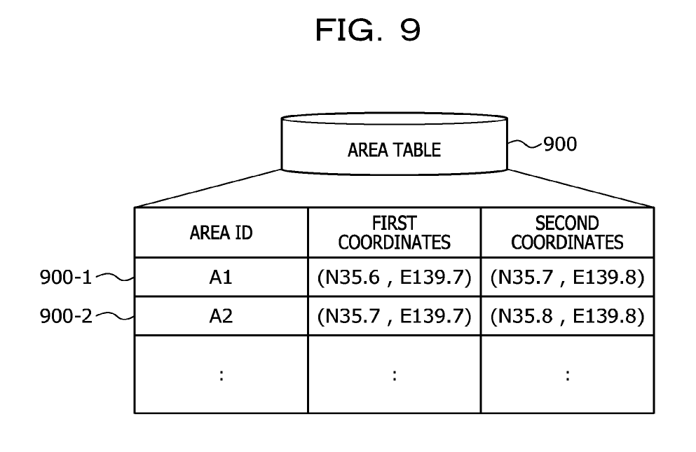

FIG. 9 is an explanatory diagram illustrating an example of stored content of an area table 900. In FIG. 9, the area table 900 includes fields of an area ID, first coordinates, and second coordinates, and stores area information (for example, area information 900-1, 900-2) as a record when information is set into these fields.

Here, the area ID is an identifier that identifies an area A partitioned and divided on the map. The area A is, for example, a rectangular area of a size approximately equivalent to several 10 kilometers (length)×several 10 kilometers (width). The first coordinates indicate lower left coordinates (latitude, longitude) of the area A. The second coordinates indicate upper right coordinates (latitude, longitude) of the area A.

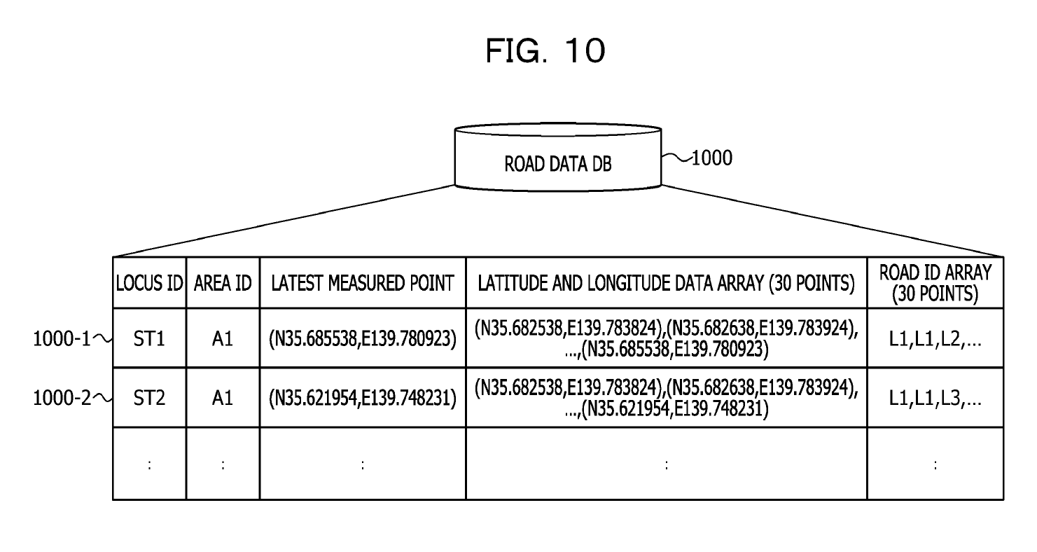

FIG. 10 is an explanatory diagram illustrating an example of stored content of a road data DB 1000. In FIG. 10, the road data DB 1000 includes fields of a locus ID, an area ID, the latest measured point, a latitude and longitude data array, and a road ID array, and stores road data (for example, road data 1000-1, 1000-2) as a record when information is set into these fields.

Here, the locus ID is an identifier that identifies the locus (route) of the vehicle C traveling on a road. Here, the area ID is an identifier that identifies an area A. The latest measured point is coordinates (latitude and longitude data) of the latest measured point P_{N} among N measured points P₁ to P_{N} included in the latitude and longitude data array.

The latitude and longitude data array is travel information (movement information) indicating a time series variation of the location of the vehicle C traveling on the road. Specifically, the latitude and longitude data array is a time series arrangement of coordinates (latitude and longitude data indicating the location of the vehicle C) of N measured points P₁ to P_{N} measured at predetermined time intervals (for example, at intervals of 10 minutes). Here, N is [N=30].

However, coordinates of the measured points P₁ to P_{N} indicated by the latitude and longitude data array are, for example, latitude and longitude data indicating the location of the post-correction vehicle C obtained by the correction processing (high precision MM processing) that removes an error, caused due to the location of the multiple satellites S varying from moment to moment or influences of the multipath, the ionosphere, the troposphere, and so on.

The road ID array is road information indicating the road corresponding to the coordinates of the measured points P₁ to P_{N} included in the latitude and longitude data array. Specifically, the road ID array is a time series arrangement of road IDs identifying the road corresponding to the coordinates of N (in this case, 30 points) measured points P₁ to P_{N}. The road corresponding to the coordinates of the measured points P₁ to P_{N} is a road identified by map matching of measured points P₁ to P_{N}.

(Functional Configuration Example of Information Processing Apparatus 101)

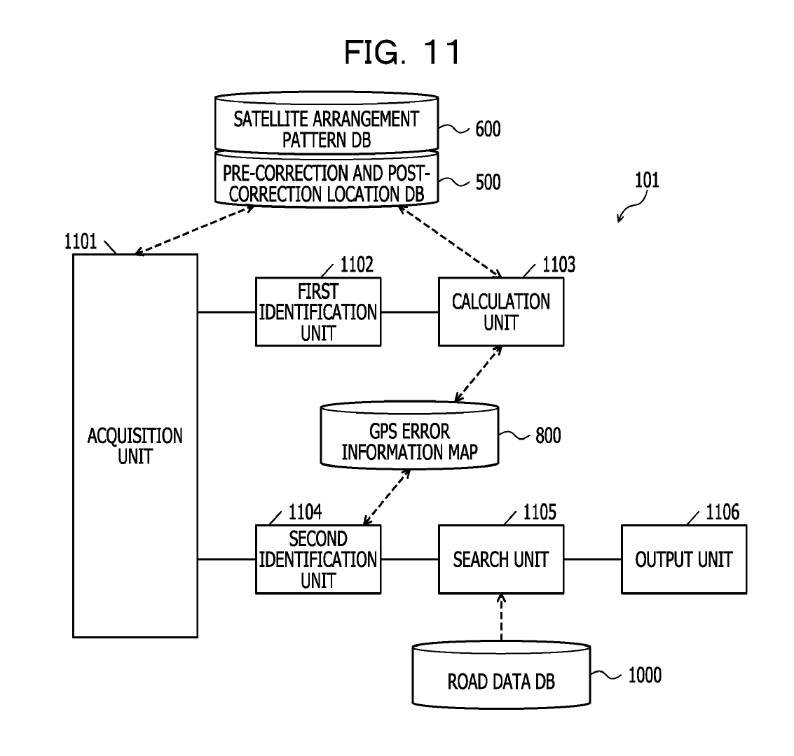

FIG. 11 is a block diagram illustrating a functional configuration example of the information processing apparatus 101. In FIG. 11, the information processing apparatus 101 includes an acquisition unit 1101, a first identification unit 1102, a calculation unit 1103, a second identification unit 1104, a search unit 1105, and an output unit 1106. The components including the acquisition unit 1101 to the output unit 1106 provide functions as a controller. Specifically, the components implement the functions, for example, by causing the CPU 301 to execute programs stored in a storage device such as the memory 302 and disk 305 illustrated in FIG. 3 or by the I/F 303. Processing result of these function units is stored, for example, in a storage device such as the memory 302 and the disk 305.

<Pre-Processing>

First, each of the function units involved in the pre-processing is described. The pre-processing is a processing executed before a real time processing described later.

The acquisition unit 1101 acquires pre-correction and post-correction location information. The pre-correction and post-correction location information used herein is information representing a location and measurement time of a vehicle C (terminal device T) measured with the GPS and a post-correction location obtained by the correction processing that removes an error from the measurement time, in association with each other. The error is, for example, an error due to the locations of multiple satellites varying from moment to moment or influences of the multipath, the ionosphere, the troposphere, and so on.

Specifically, for example, the acquisition unit 1101 may acquire the pre-correction and post-correction location information by receiving the pre-correction and post-correction location information from an external computer via the I/F 303. Alternatively, the acquisition unit 1101 may acquire the pre-correction and post-correction location information, for example, by user's input operation through an input device (not illustrated).

Acquired pre-correction and post-correction location information is stored, for example, in the pre-correction and post-correction location DB 500 illustrated in FIG. 5. Thus, post-correction location of the vehicle C corrected in consideration of effects of the multipath and the like may be accumulated in association with a location and measurement time of the vehicle C measured with the GPS.

The pre-correction and post-correction location information may be generated in the information processing apparatus 101. For example, the information processing apparatus 101 may generate the pre-correction and post-correction location information by acquiring location information indicating a location and measurement time of the vehicle C measured with the GPS from the terminal device T and then implementing correction processing to remove an error from a location indicated by the location information.

The acquisition unit 1101 acquires satellite arrangement pattern history information. The satellite arrangement pattern history information used herein is information indicating past arrangement patterns P of the multiple satellites S. The arrangement pattern P is classified based on the combination of the locations of multiple satellites that vary from moment to moment. The locations of the satellites S is determined, for example, based on the angle range to which a satellite belongs, and a distance from the reference point as illustrated in FIG. 7.

Specifically, for example, the acquisition unit 1101 may acquire the satellite arrangement pattern history information by receiving the satellite arrangement pattern history information from an external computer via the I/F 303. Alternatively, the acquisition unit 1101 may acquire the satellite arrangement pattern history information, for example, by user's input operation through an input device (not illustrated).

Acquired satellite arrangement pattern history information is stored, for example, in the satellite arrangement pattern DB 600 illustrated in FIG. 6. Thus, information of the arrangement pattern P classified based on the combination of the locations of satellites S1 to S4 that vary from moment to moment may be accumulated.

The satellite arrangement pattern history information may be generated in the information processing apparatus 101. For example, the information processing apparatus 101 may generate the satellite arrangement pattern history information sequentially by acquiring navigation information of the multiple satellites S at regular intervals and then identifying the arrangement pattern P based on the navigation information.

The acquisition unit 1101 acquires navigation information of each of the satellites S. The navigation information used herein is information for identifying the locations of the satellites S, such as, for example, ephemeris data and almanac data obtained from each of the satellites S. The ephemeris data is track information indicating the locations of the satellites S. The almanac data is rough track information of each of the satellites S.

Specifically, for example, the acquisition unit 1101 causes the GPS receiver 306 illustrated in FIG. 3 to receive the navigation information for identifying the location of satellites S1 to S4 for the coming 24 hours from satellites S1 to S4 and thereby acquires the navigation information of satellites S1 to S4. Alternatively, the acquisition unit 1101 may acquire the navigation information of satellites S1 to S4, for example, by user's input operation through an input device (not illustrated).

The first identification unit 1102 identifies the arrangement pattern P of the multiple satellites S based on the acquired navigation information of each of the satellites S. Specifically, for example, the first identification unit 1102 calculates the location (angle range and distance) of satellites S1 to S4 for every fixed time intervals from the reference time based on the navigation information of satellites S1 to S4 for the 24 hours and thereby identifies the arrangement pattern P of satellites S1 to S4. The reference time is, for example, 00 hour 00 minute. The fixed time may be set as desired, for example, to about 10 minutes.

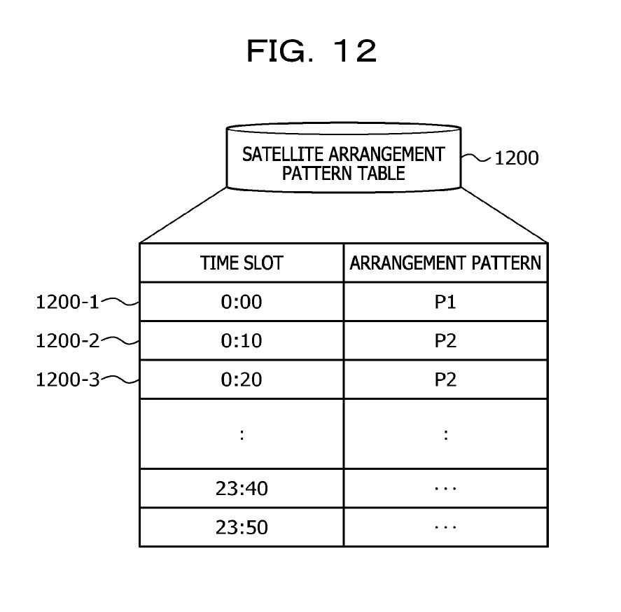

The identified arrangement pattern P is stored, for example, into the satellite arrangement pattern table 1200 such as illustrated in FIG. 12. The satellite arrangement pattern table 1200 is implemented, for example, by a storage device such as the memory 302 and the disk 305.

FIG. 12 is an explanatory diagram illustrating an example of stored content of the satellite arrangement pattern table 1200. In FIG. 12, the satellite arrangement pattern table 1200 includes fields of a time slot and an arrangement pattern, and stores satellite arrangement pattern information (for example, satellite arrangement pattern information 1200-1 to 1200-3) as a record when information is set into these fields.

Here, the time slot is a time slot for each fixed time interval from a reference time. In the example of FIG. 12, the time slot is a time slot for every 10 minutes with 00 hour 00 minute as a reference time. The arrangement pattern is an arrangement pattern P classified based on the combination of the locations of the multiple satellites S (for example, satellites S1 to S4 illustrated in FIG. 2) for each of the time slots.

The satellite arrangement pattern table 1200 may identify, at 10 minute intervals, the arrangement pattern P of satellites S1 to S4 that varies from moment to moment for the coming 24 hours.

Referring back to FIG. 11, the calculation unit 1103 calculates a range search area corresponding to the zone for each of the arrangement patterns P of the multiple satellites S. The zone used herein is a place of a fixed range partitioned on the map. Size of the zone may be set as desired. For example, the zone is a rectangular area of a size approximately equivalent to several 10 kilometers (length)×several 10 kilometers (width).

However, in such a place that is likely to be affected by the multipath, an area smaller than other places may be set as the zone. In such a place that is unlikely to be affected by the multipath, an area larger than other places may be set as the zone. Minimum unit (length or width) of the zone may be a minimum unit of the road length. The first range described with reference to FIG. 1 corresponds, for example, to the zone.

The range search area is a range where a post-correction location obtained by the correction processing that removes an error from the measured location within the zone exists. The measured location within the zone is a location of the vehicle C within the zone positioned with the GPS. The error is, for example, an error due to the locations of multiple satellites varying from moment to moment or influences of the multipath, the ionosphere, the troposphere, and so on. The second range described with reference to FIG. 1 corresponds, for example, to the range search area.

Specifically, for example, the calculation unit 1103 selects the arrangement pattern P in the satellite arrangement pattern table 1200 (see FIG. 12). Then, the calculation unit 1103 acquires, from the pre-correction and post-correction location DB 500, pre-correction and post-correction location information indicating the location (pre-MM location) of the vehicle C measured with the GPS in the selected arrangement pattern P.

The arrangement pattern P in which the pre-MM location indicated by the pre-correction and post-correction location information is measured may be identified, for example, from the satellite arrangement pattern DB 600 illustrated in FIG. 6 with the measurement time as a key. For example, a pre-MM location indicated by the pre-correction and post-correction location information of a measurement time included in a period between 00 hour 00 minute 00 second and 00 hour 09 minutes 59 seconds of Jan. 1, 2016 is a location measured in an arrangement pattern P1.

Next, the calculation unit 1103 extracts, for each of zones, pre-correction and post-correction location information that includes the pre-MM location within the zone from extracted pre-correction and post-correction location information. Then, the calculation unit 1103 calculates distribution of the post-MM location based on the extracted pre-correction and post-correction location information for each zone. Next, the calculation unit 1103 identifies, for example, the distribution range of 3σ of the post-MM locations as a range search area corresponding to the zone.

Then, the calculation unit 1103 calculates the shape of the identified range search area. The shape of the range search area may be an elliptical shape or a rectangular shape. In the case of the elliptical shape, the calculation unit 1103 calculates, as the shape of the range search area, coordinates (longitude and latitude) of the center position of the range search area, and length (unit: meter) of the major axis and minor axis.

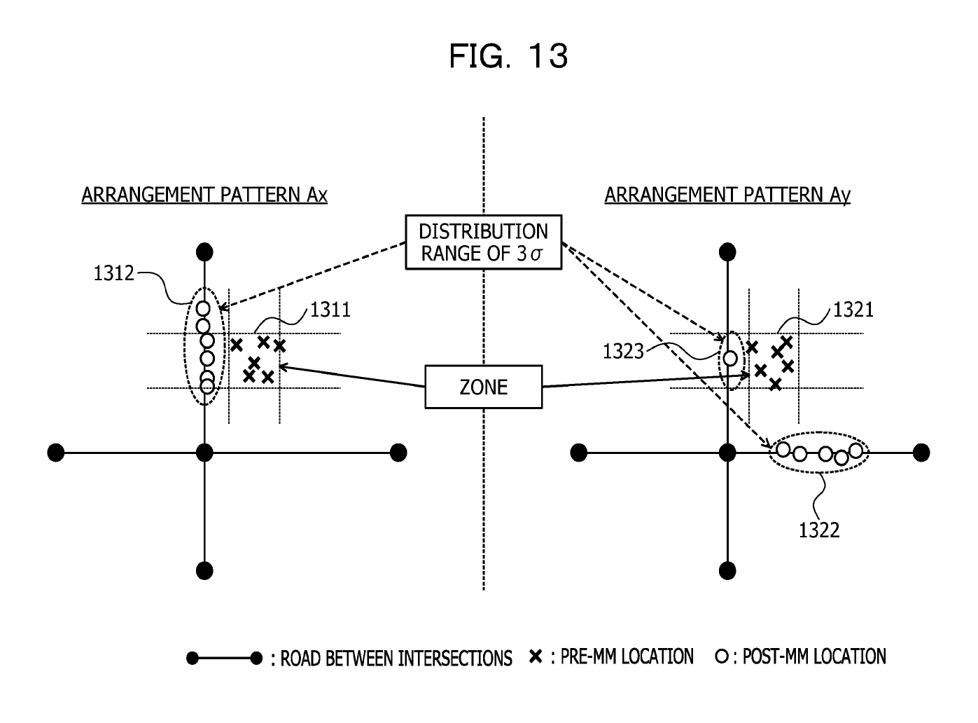

Here, a specific example of the range search area is described with reference to FIG. 13.

FIG. 13 is an explanatory diagram illustrating a specific example of the range search area. In FIG. 13, a zone 1311 on a map and a range search area 1312 corresponding to the zone 1311 are illustrated for an arrangement pattern Ax. The range search area 1312 indicates a distribution range of 3σ of the post-MM locations corresponding to the pre-MM locations within the zone 1311.

For an arrangement pattern Ay, a zone 1321 on a map and range search areas 1322, 1323 corresponding to the zone 1321 are illustrated. The range search areas 1322, 1323 are areas independent of each other, and indicate a distribution range of 3σ of the post-MM locations corresponding to the pre-MM locations within the zone 1321.

The calculation unit 1103, for example, executes the above series of processings repeatedly until there is no unselected arrangement pattern P not selected from the satellite arrangement pattern table 1200.

Thus, the shape of the range search area for each of the zones may be calculated for each of arrangement patterns P emerging during the coming 24 hours. Information identifying the shape of the range search area for each of the zones calculated for each of arrangement patterns P is stored, for example, into a GPS error information map 800 illustrated in FIG. 8.

<Real Time Processing>

Next, function units involved in the real time processing executed in response to acquisition of the positioning data D indicating the location measured with the GPS are described.

Referring back to FIG. 11, the acquisition unit 1101 acquires positioning data D indicating the location measured with the GPS. Specifically, for example, the acquisition unit 1101 acquires positioning data D by receiving, from a terminal device T mounted on a vehicle C, the positioning data D indicating time series variation of the location of the vehicle C positioned with the GPS.

The positioning data D used herein is array data indicating, in a time series manner, coordinates of N measured points q₁ to q_{N} (locations of vehicle C) measured at predetermined time intervals (for example, at intervals of 10 seconds) with the GPS. The predetermined time intervals may be set as desired, for example, to about 10 minutes. N may be set as desired, for example, to about 30 minutes.

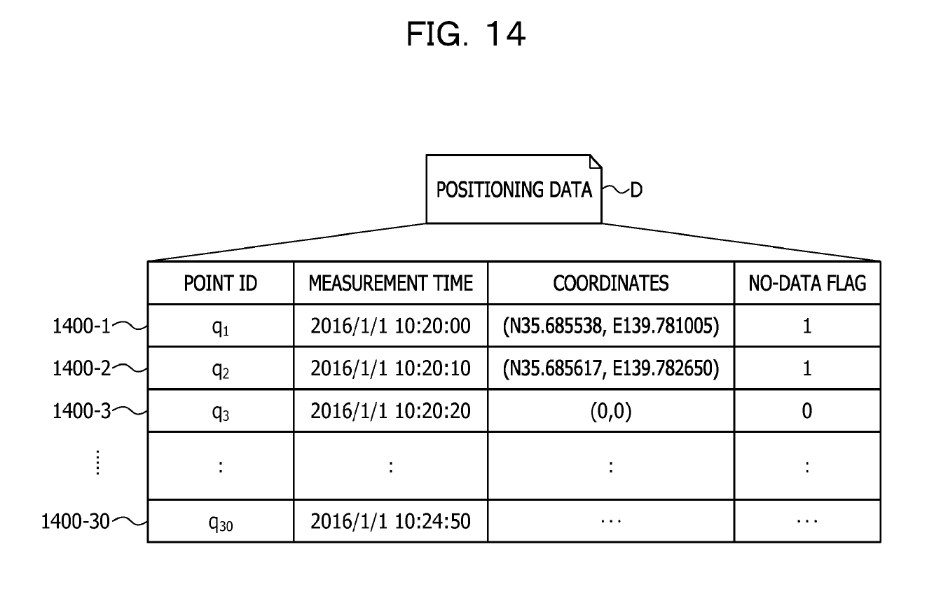

Here, a specific example of the positioning data D is described with reference to FIG. 14.

FIG. 14 is an explanatory diagram illustrating a specific example of the positioning data D. In FIG. 14, the positioning data D is information indicating, in a time series manner, coordinates (latitude, longitude) of 30 measured points q₁ to q₃₀ measured at intervals of 10 seconds with the GPS, and includes location information 1400-1 to 1400-30.

Location information 1400-1 to 1400-30 is information indicating a point ID, a measurement time, coordinates, and a no-data flag in association with each other. The point ID is an identifier that identifies the measured point q. The measurement time is a time when the location of the measured point q is measured. The coordinates are coordinates (latitude, longitude) indicating the location of the measured point q.

The no-data flag is a flag used to determine a measured point q where positioning was not performed due to a failure such as non-reception of the radio wave from satellites S. A no-data flag [1] used herein indicates that the location of the vehicle C was measured. On the other hand, a no-data flag [0] used herein indicates that the location of the vehicle C was not measured. In a case where the no-data flag is [0], (0, 0) is set to the coordinates of the measured point q.

The positioning data D may include, for example, identification information identifying the vehicle C or the terminal device T mounted on the vehicle C.

Referring back to FIG. 11, a second identification unit 1104 refers to the correspondence relationship between a zone where the location measured with the GPS exists and a range search area corresponding to the zone for each of arrangement patterns P of the multiple satellites S, and identifies the range search area corresponding to the zone including the location indicated by the positioning data D.

Specifically, for example, the second identification unit 1104 first refers to the GPS error information map 800 and identifies the arrangement pattern P at the time when a location indicated by the acquired positioning data D is measured. More specifically, for example, the second identification unit 1104 identifies the arrangement pattern P corresponding to a time slot including the measurement time of the positioning data D at the latest measured point q_{N}.

Here, the latest measured point q_{N} is a measured point q_{N} of the latest measurement time among N measured points q₁ to q_{N} indicated by the positioning data D. With the positioning data D illustrated in FIG. 14 as an example, the measured point q30 indicated by location information 1400-30 is the latest measured point. In a case where the no-data flag at the measured point q30 is [0], a measured point q of the latest measurement time among measured points q of the no-data flag [1] is the latest measured point.

Next, the second identification unit 1104 refers to the GPS error information map 800 and identifies a shape of the range search area corresponding to the combination of the identified arrangement pattern P and the zone including the latest measured point q_{N} of the positioning data D. Thus, the range search area corresponding to the zone including the location (latest measured point q_{N}) indicated by the positioning data D may be identified.

The search unit 1105 identifies the road corresponding to the location indicated by positioning data D based on the identified range search area. Specifically, for example, the search unit 1105 refers to the road data DB 1000 illustrated in FIG. 10 and retrieves road data which includes at least any one location of the vehicle C indicated by the latitude and longitude data including the latitude and longitude data array within an area (range search area) of a shape of the identified range search area.

More specifically, for example, the search unit 1105 refers to the road data DB 1000 and retrieves road data which includes the latest measured point p_{N} of the latitude and longitude data array within the identified range search area. Thus, road data including the latest measured point p_{N} within a range search area corresponding to a zone including the latest measured point q_{N} of the positioning data D may be narrowed down as a candidate indicating the road corresponding to the location indicated by the positioning data D.

The road data DB 1000 stores road data for multiple areas A. Therefore, amount of processing may increase if the entire road data within the road data DB 1000 is searched. Thus, for example, the search unit 1105 may refer to an area table 900 illustrated in FIG. 9 and identify an area A that includes a location (for example, latest measured point q_{N}) indicated by the positioning data D. Then, the search unit 1105 may retrieve road data that includes the latest point coordinates of the latitude and longitude data array within the range search area, with a road data group corresponding to the identified area A as a target to be searched. Thus, processing time and processing load for the retrieval of the road data may be reduced.

In the description below, a latitude and longitude data array of the road data retrieved as a candidate record may be represented by “latitude and longitude data array STk”. “STk” indicates a latitude and longitude data array (k=1, 2, . . . ) of the road data including the locus ID “STk”.

Next, the search unit 1105 calculates a similarity indicating a degree of the similarity between the latitude and longitude data array STk of the retrieved road data and the positioning data D. Specifically, for example, the search unit 1105 calculates a similarity between the latitude and longitude data array STk and the positioning data D based on the an Eucrid distance between each of measured points p indicated by the latitude and longitude data array STk and each of measured points q indicated by the positioning data D.

More specifically, for example, the search unit 1105 may calculate a dissimilarity NR^{(k)} between the latitude and longitude data array STk and the positioning data D by using the following formula (1). An inverse number of the dissimilarity NR^{(k)} is equivalent to a similarity between the latitude and longitude data array STk and the positioning data D.

Wherein (xᵢ, yᵢ) are coordinates at an ith (i=1, 2, . . . , N) measured point qᵢ from the first measured point among measured points qᵢ to q_{N} indicated by the positioning data D as illustrated in the following formula (2). wᵢ is a no-data flag at the measured point qᵢ. (X^{(k)}ᵢ, Y^{(k)}ᵢ) are coordinates at an ith measured point P₁ from the first measured point among measured points P₁ to p_{N} indicated by the latitude and longitude data array as illustrated in the following formula (3).

$$\begin{matrix}{NR}^{( k )} = {\sum }_{i = 1}^{N} {w}_{i} ( {( {x}_{i} - {X}_{i}^{( k )} )}^{2} + {( {y}_{i} - {Y}_{i}^{( k )} )}^{2} ) & ( 1 ) \\ ( {q}_{1} , {q}_{2} , … , {q}_{N} ) = [ ( {x}_{1} , {y}_{1} ) , ( {x}_{2} , {y}_{2} ) , … , ( {x}_{N} , {y}_{N} ) ] & ( 2 ) \\ ( {p}_{1} , {p}_{2} , … , {p}_{N} ) = [ ( {X}_{1}^{( k )} , {Y}_{1}^{( k )} ) ] , ( {X}_{2}^{( k )} , {Y}_{2}^{( k )} ) , … , ( {X}_{N}^{( k )} , {Y}_{N}^{( k )} ) ] & ( 3 )\end{matrix}$$

The search unit 1105 identifies the road corresponding to the location indicated by positioning data D based on the calculated dissimilarity NR^{(k)}. More specifically, for example, in a case where the calculated dissimilarity NR^{(k)} is less than the threshold α, the search unit 1105 may identify the roads indicated by the road ID array corresponding to the latitude and longitude data array STk as roads corresponding to the measured points a indicated by the positioning data D.

More specifically, in a case where the calculated dissimilarity NR^{(k)} is larger than the threshold α, the search unit 1105 does not identify the road corresponding to the location indicated by the positioning data D. The threshold α may be set as desired. Thus, in a case where there exists no latitude and longitude data array STk similar with the positioning data D, drop of map matching accuracy may be avoided by not identifying the road corresponding to the location indicated by the positioning data D.

In a case where multiple latitude and longitude data arrays STk are retrieved, the search unit 1105 may identify a road indicated by the road ID array corresponding to the latitude and longitude data array STk where the calculated dissimilarity NR^{(k)} is smallest, as a road corresponding to the location indicated by the positioning data D. In a case where the minimum dissimilarity NR^{(k)} is larger than the threshold α, the search unit 1105 may be configured not to identify the road corresponding to the location indicated by the positioning data D.

Thus, each of roads indicated by the road ID array corresponding to a latitude and longitude data array STk most similar with the positioning data D may be identified as a road for each of the measured points q indicated by the positioning data D, while avoiding drop of the map matching accuracy.

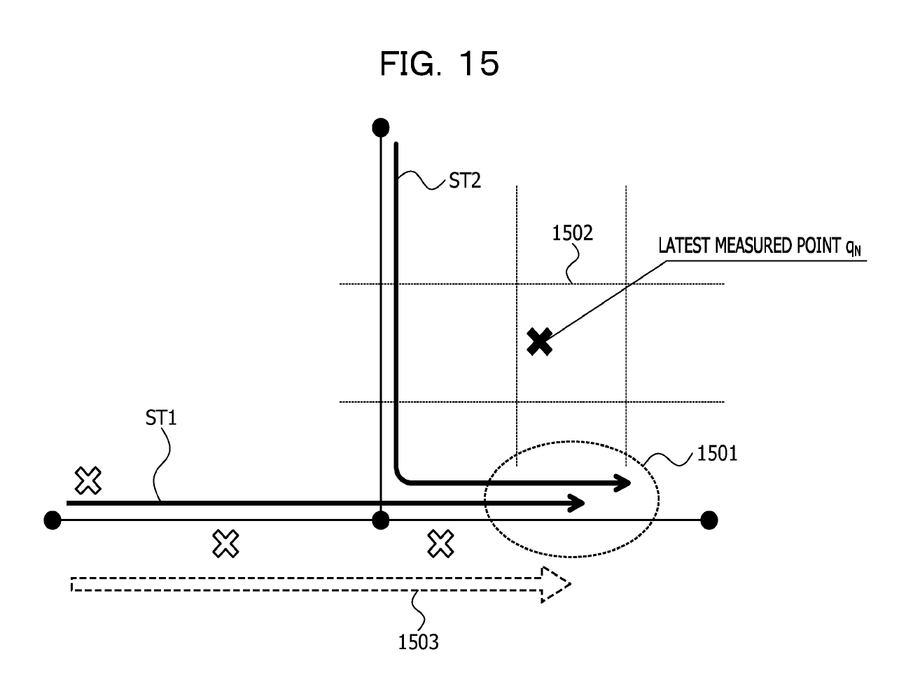

Here, an example of identifying the road corresponding to the location indicated by the positioning data D is described with reference to FIG. 15. Here, description is made by using a case where latitude and longitude data arrays ST1, ST2 are retrieved as candidate records indicating the road corresponding to the location indicated by the positioning data D, as an example.

FIG. 15 is an explanatory diagram illustrating an identification example of the road corresponding to the location indicated by the positioning data D. In FIG. 15, a mark x represents each of measured points q of the positioning data D. However, FIG. 15 illustrates an extracted portion of the measured point q. The range search area 1501 is a range search area corresponding to the zone 1502 including the latest measured point q_{N} of the positioning data D.

Solid line arrows ST1, ST2 are loci (routes) indicated by latitude and longitude data arrays ST1, ST2 in which the latest measured points p_{N} is included in the range search area 1501. However, FIG. 15 illustrates an extracted portion of the loci (routes). In FIG. 15, a line segment connecting marks •with each other represents a road between intersections. A dotted arrow 1503 represents the direction of locus (route) in which a vehicle C actually travels when the positioning data D is measured.

In this case, the search unit 1105 calculates dissimilarities NR⁽¹⁾, NR⁽²⁾ between the positioning data D and latitude and longitude data arrays ST1, ST2 respectively by using, for example, the above formula (1). Here, assume that the dissimilarity NR⁽¹⁾ is smaller than the dissimilarity NR⁽²⁾, and the dissimilarity NR⁽¹⁾ is less than the threshold α.

In this case, the search unit 1105 identifies the road indicated by the road ID array corresponding to the latitude and longitude data array ST1 as a road corresponding to the location indicated by the positioning data D. Thus, even if the latest measured point q_{N} of the positioning data D indicates a location different from an actual location due to effects of the multipath or the like, a road where the vehicle C actually travels may be identified.

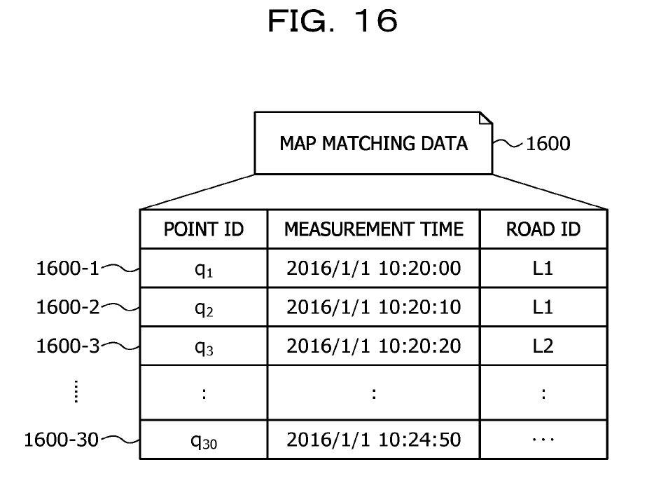

Referring back to FIG. 11, the output unit 1106 outputs the location indicated by the positioning data D and the road corresponding to the identified location in association with each other. Specifically, for example, the output unit 1106 may be configured to output map matching data 1600 such as illustrated in FIG. 16. Output format of the output unit 1106 includes, for example, storage into a storage device such as the memory 302 and disk 305 and transmission to an external computer via the I/F 303.

(Specific Example of Map Matching Data 1600)

FIG. 16 is an explanatory diagram illustrating a specific example of the map matching data 1600. In FIG. 16, the map matching data 1600 includes fields of a point ID, a measurement time, and a road ID, and stores map matching results 1600-1 to 1600-30 as a record when information is set into these fields.

Here, the point ID is an identifier that identifies the measured point q. The measurement time is a time when the location of the measured point q is measured. The point ID is an identifier that identifies the road corresponding to the location of measured point q. Although not illustrated, the map matching data 1600 may include coordinates (latitude, longitude) of each of the measured points q.

The map matching data 1600 may identify time (measurement time) and road where a vehicle C travels and thereby may facilitate recognition of road situations in real time.

The map matching data 1600 may include identification information identifying a vehicle C or a terminal device T mounted on the vehicle C. Identification information of the vehicle C or terminal device T is included, for example, in the positioning data D. Thus, it is possible to identify time (measurement time) and road where a vehicle C travels.

(Various Processing Procedures of Information Processing Apparatus 101)

Next, various processing procedures of the information processing apparatus 101 are described.

<Pre-Processing>

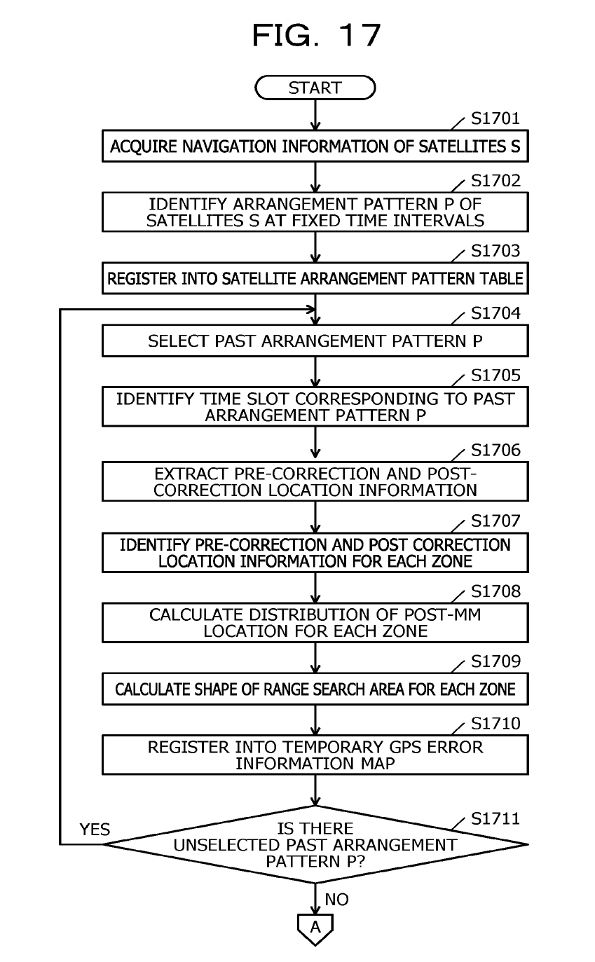

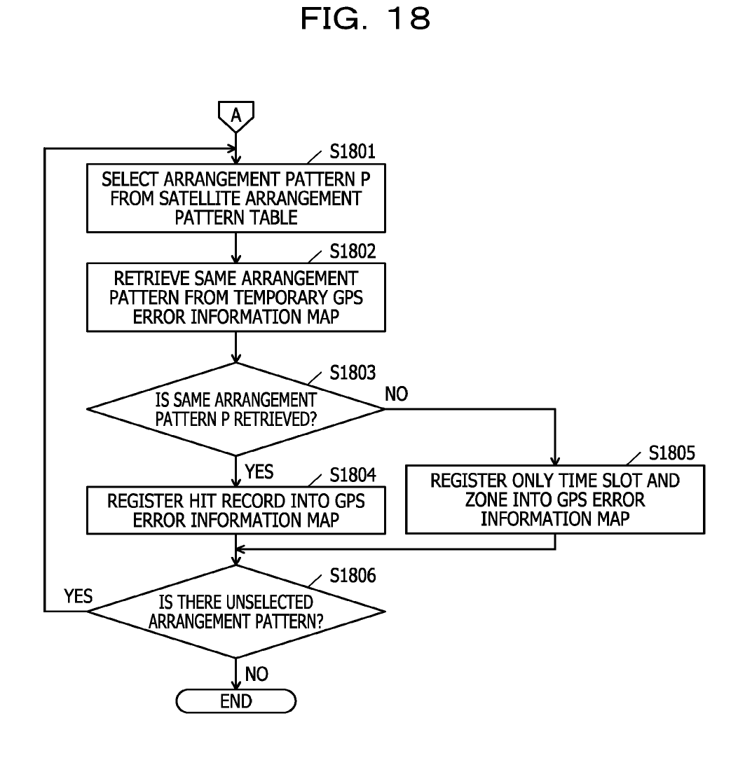

First, a processing procedure of the information processing apparatus 101 is described with reference to FIGS. 17 and 18. The pre-processing is implemented at regular intervals, for example, at 24 hours intervals.

FIGS. 17 and 18 are flowcharts illustrating an example of the pre-processing procedure of the information processing apparatus 101. In the flowchart of FIG. 17, the information processing apparatus 101 first acquires navigation information identifying the locations of the satellites S (for example, satellites S1 to S4) for the coming 24 hours (step S1701).

Next, the information processing apparatus 101 calculates the locations (angle range and distance) of the satellites S for every fixed time intervals from the reference time based on the acquired navigation information of the satellites S and thereby identifies the arrangement pattern P of the multiple satellites S (step S1702). The reference time is, for example, 00 hour 00 minute. The fixed time is, for example, 10 minutes. Then, the information processing apparatus 101 registers arrangement patterns P identified for every fixed time into the satellite arrangement pattern table 1200 (step S1703).

Next, the information processing apparatus 101 selects an unselected past arrangement pattern P not selected from the satellite arrangement pattern DB 600 (step S1704). Then, the information processing apparatus 101 identifies a time slot corresponding to the selected past arrangement pattern P with reference to the satellite arrangement pattern DB 600 (step S1705).

Next, the information processing apparatus 101 extracts pre-correction and post-correction location information in which the measurement time is included in the identified time slot, from the pre-correction and post-correction location DB 500 (step S1706). Thus, the pre-correction and post-correction location information indicating the location (pre-MM location) of the vehicle C measured in the past arrangement pattern P selected in the step S1704 may be extracted.

Next, the information processing apparatus 101 refers to the extracted pre-correction and post-correction location information, and identifies, for each of zones partitioned and divided on the map, pre-correction and post-correction location information wherein the pre-MM location is included in the zone (step S1707). Then, the information processing apparatus 101 calculates distribution of the post-MM location based on the identified pre-correction and post-correction location information for each of zones (step S1708).

Next, the information processing apparatus 101 calculates the shape of the range search area based on the distribution range of 3σ of the post-MM locations for each of zones (step S1709). Then, the information processing apparatus 101 registers the shape of the range search area for each of the calculated zones into a temporary GPS error information map in association with the selected past arrangement pattern P (step S1710).

The temporary GPS error information map is an intermediate file created for generating the GPS error information map 800. Date structure of the temporary GPS error information map is the same as the GPS error information map 800. Therefore, illustration and description thereof is omitted.

Next, the information processing apparatus 101 determines whether there is any unselected past arrangement pattern P not selected from the satellite arrangement pattern DB 600 (step S1711). Here, in a case where there is an unselected past arrangement pattern P (step S1711: Yes), the information processing apparatus 101 returns to the step S1704. On the other hand, in a case where there is no unselected past arrangement pattern P (step S1711: No), the information processing apparatus 101 proceeds to the step S1801 illustrated in FIG. 18.

In the flowchart of FIG. 18, the information processing apparatus 101 first selects an unselected past arrangement pattern P not selected from the satellite arrangement pattern table 1200 (step S1801). Next, the information processing apparatus 101 retrieves the same arrangement pattern P as the selected arrangement pattern P from the temporary GPS error information map (step S1802).

Then, the information processing apparatus 101 determines whether the same arrangement pattern P is retrieved (step S1803). Here, in a case where the same arrangement pattern P is retrieved (step S1803: Yes), the information processing apparatus 101 registers the hit record within the temporary GPS error information map corresponding to the retrieved arrangement pattern P into the GPS error information map 800 (step S1804), and proceeds to the step S1806.

On the other hand, in a case where the same arrangement pattern P is not retrieved (step S1803: No), the information processing apparatus 101 registers only the time slot and the zone for the selected arrangement pattern P into the GPS error information map 800 (step S1805). In this case, the shape of the range search area for each of the zones is “−(null)”.

Then, the information processing apparatus 101 determines whether there is any unselected arrangement pattern P not selected from the satellite arrangement pattern table 1200 (step S1806). Here, in a case where there is an unselected arrangement pattern (step S1806: Yes), the information processing apparatus 101 returns to the step S1801.

On the other hand, in a case where there is no unselected arrangement pattern P (step S1806: No), the information processing apparatus 101 ends a series of processings according to the flowchart. Thus, the GPS error information map 800, in which the shape of the range search area for each of the zones is registered, may be generated for each of arrangement patterns P emerging during the coming 24 hours.

<Real Time Processing Procedure>

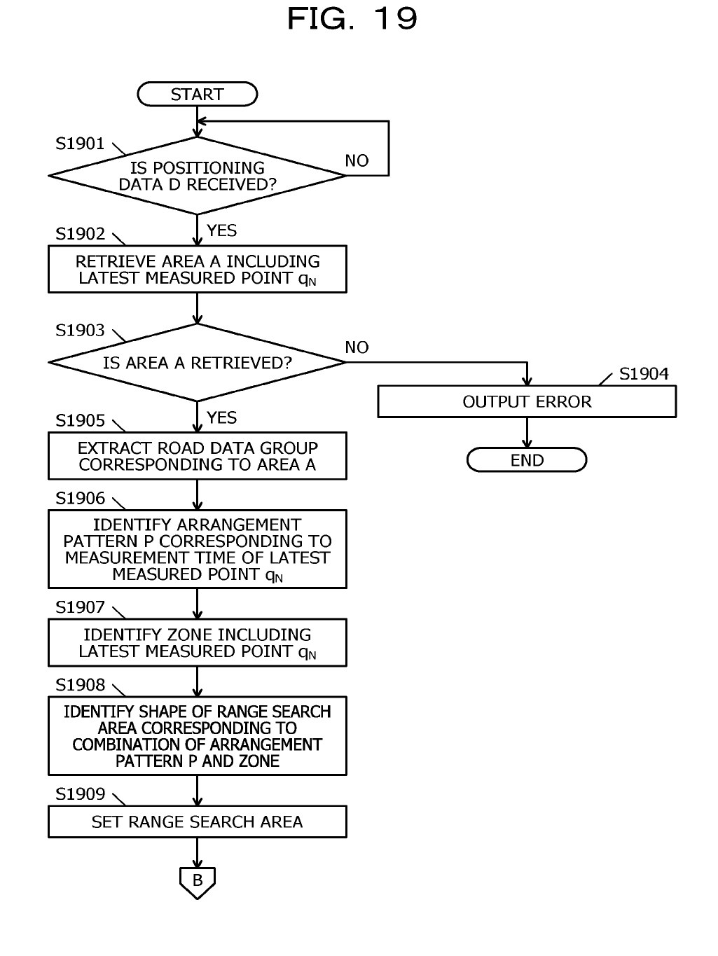

Next, a real time processing procedure of the information processing apparatus 101 is described with reference to FIGS. 19 to 21.

FIGS. 19 to 21 are flowcharts illustrating an example of the real time processing procedure of the information processing apparatus 101. In the flowchart of FIG. 19, the information processing apparatus 101 first determines whether positioning data D indicating a time series variation of the location of a vehicle C is received from a terminal device T mounted on the vehicle C (step S1901).

Here, the information processing apparatus 101 waits until receiving the positioning data D (step S1901: No). Then, in a case where the positioning data D is received (step S1901: Yes), the information processing apparatus 101 refers to the area table 900 and retrieves an area A including the latest measured point q_{N} of the positioning data D (step S1902).

Then, the information processing apparatus 101 determines whether the area A is retrieved (step S1903). Here, in a case where the area A is not retrieved (step S1903: No), the information processing apparatus 101 outputs an error indicating failure of map matching of the positioning data D (step S1904), and ends a series of processings according to the flowchart.

On the other hand, in a case where the area A is retrieved (step S1903: Yes), the information processing apparatus 101 extracts a road data group corresponding to the area ID of the identified area A from the road data DB 1000 (step S1905). Next, the information processing apparatus 101 refers to the GPS error information map 800 and identifies the arrangement pattern P corresponding to the time slot including the measurement time of the positioning data D at the latest measured point q_{N}(step S1906).

Then, the information processing apparatus 101 identifies the zone including the latest measured point q_{N} (step S1907). Next, the information processing apparatus 101 refers to the GPS error information map 800 and identifies the shape of the range search area corresponding to the combination of the identified arrangement pattern P and the zone including the latest measured point q_{N} (step S1908).

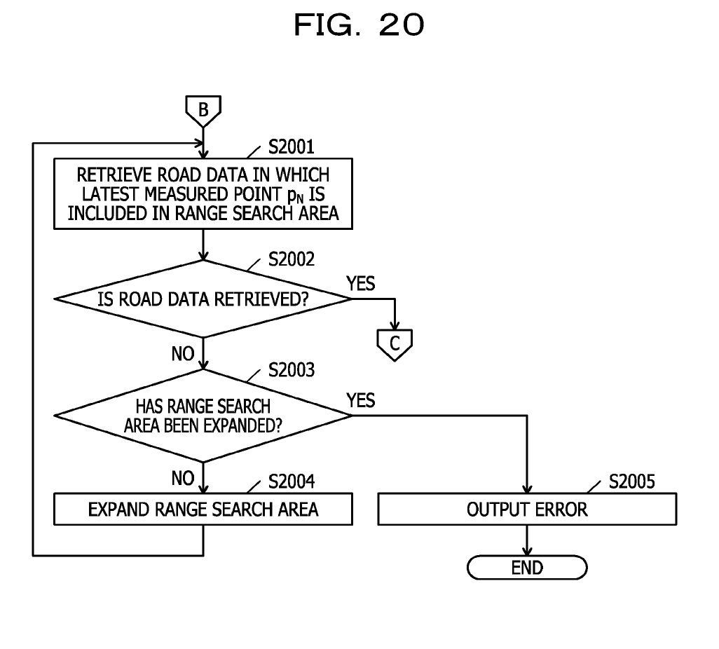

Then, the information processing apparatus 101 sets the range search area based on the shape of the range search area identified (step S1909) and proceeds to the step S2001 illustrated in FIG. 20. In a case where the shape of the range search area is [-], the information processing apparatus 101 sets the zone identified in the step S1907 as a range search area.

In the flowchart of FIG. 20, the information processing apparatus 101 first retrieves the road data which includes the latest measured point p_{N} of the latitude and longitude data array within the set range search area, from the road data group extracted in the step S1905 (step S2001). Then, the information processing apparatus 101 determines whether the road data is retrieved (step S2002).

Here, in a case where the road data is not retrieved (step S2002: No), the information processing apparatus 101 determines whether the range search area has been expanded (step S2003). In a case where the range search area has not been expanded (step S2003: No), the information processing apparatus 101 expands the range search area (step S2004) and returns to the step S2001.

The method of expanding the range search area may be set as desired. For example, the information processing apparatus 101 may expand the range search area by multiplying the major axis and minor axis of the shape of the range search area by β. β is a value larger than 1, and is set, for example, to about “4/3”.

On the other hand, in the step S2003, in a case where the range search area has been expanded (step S2003: Yes), the information processing apparatus 101 outputs an error (step S2005), and ends a series of processings according to the flowchart. The error indicates, for example, failure of map matching of the positioning data D.

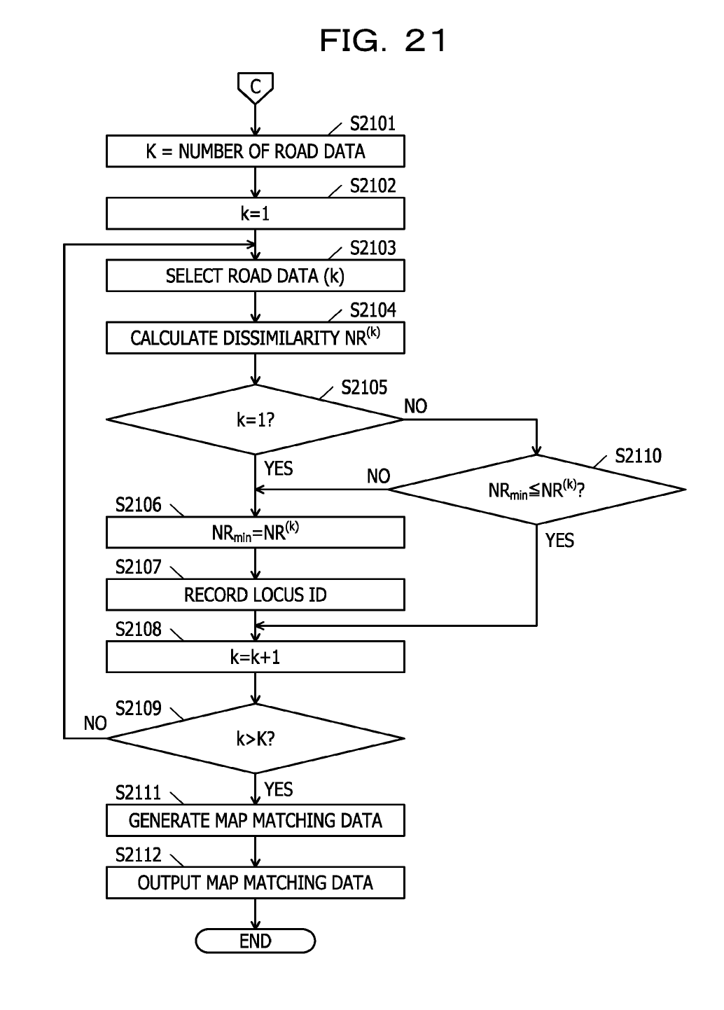

In the step S2002, in a case where the road data is retrieved (step S2002: Yes), the information processing apparatus 101 proceeds to the step S2101 illustrated in FIG. 21.

In the flowchart of FIG. 21, the information processing apparatus 101 first sets the number of road data retrieved in the step S2002 to a value of a parameter k (step S2101). In the description below, the road data retrieved in the step S2002 is represented by “road data (1) to (k)” (k: natural number larger than 1).

Next, the information processing apparatus 101 sets “k” to “k=1” (step S2102) and selects the road data (k) from the road data (1) to (k) (step S2103). Then, the information processing apparatus 101 calculates the dissimilarity NR^{(k)} between the positioning data D and the latitude and longitude data array ST (k) of the road data (k) by using the above formula (1) (step S2104).

Next, the information processing apparatus 101 determines whether the k is 1 (k=1) (step S2105). Here, in a case where k is 1 (k=1) (step S2105: Yes), the information processing apparatus 101 sets a minimum dissimilarity NRₘᵢₙ to “NRₘᵢₙ=NR^{(k)}” (step S2106). Then, the information processing apparatus 101 records the locus ID of the road data (k) (step S2107). In a case where the locus ID has been recorded, the information processing apparatus 101 overwrites the locus ID with a new locus ID.

Next, the information processing apparatus 101 increments “k” (step S2108) and determines whether “k” is larger than “K” (step S2109). Here, in a case where “k” is smaller than “K” (step S2109: No), the information processing apparatus 101 returns to the step S2103.

In the step S2105, in a case where k is not 1 (step S2105: No), the information processing apparatus 101 determines whether the calculated dissimilarity NR^{(k)} is larger than the minimum dissimilarity NRₘᵢₙ (step S2110).

Here, in a case where the dissimilarity NR^{(k)} is larger than the minimum dissimilarity NRₘᵢₙ (step S2110: Yes), the information processing apparatus 101 proceeds to the step S2108. On the other hand, in a case where the dissimilarity NR^{(k)} is less than the minimum dissimilarity NRₘᵢₙ (step S2110: No), the information processing apparatus 101 proceeds to the step S2106.

In the step S2109, in a case where “k” is larger than “K” (step S2109: Yes), the information processing apparatus 101 generates map matching data based on the road ID array corresponding to the recorded locus ID (step S2111). Then, the information processing apparatus 101 outputs the generated map matching data (step S2112) and ends a series of processings according to the flowchart.

Thus, map matching data obtained by map matching for the location (measured points q₁ to q_{N}) of the vehicle C indicated by the positioning data D may be outputted.

As described above, the information processing apparatus 101 according to the embodiment refers to the GPS error information map 800 in response to acquisition of the positioning data D. Thus, the information processing apparatus 101 may identify the range search area corresponding to the zone including a location indicated by the positioning data D based on the arrangement pattern P at the time when the location indicated by the positioning data D is positioned. Then, the information processing apparatus 101 may identify the road corresponding to the location indicated by positioning data D based on the identified range search area.

Thus, high precision map matching may be performed by using a range search area for each of the areas determined in advance in consideration of effects of the multipath or the like varying according to the time and place, or by using a range where there is a high possibility that an actual location exists. Compared with the case where correction is implemented every time the positioning data D is acquired, real time property may be ensured by reducing a processing time taken for completion of map matching.

The information processing apparatus 101 may refer to the road data DB 1000 and retrieve road data which includes the location of the vehicle C indicated by the latitude and longitude data included in the latitude and longitude data array within the identified range search area. The information processing apparatus 101 may calculate the dissimilarity NR^{(k)} between the latitude and longitude data array STk of the retrieved road data and the positioning data D. Specifically, for example, the information processing apparatus 101 may calculate the dissimilarity NR^{(k)} based on the Eucrid distance between the coordinates of measured points q₁ to q_{N} indicated by the positioning data D and the coordinates of measured points p₁ to p_{N} indicated by the latitude and longitude data array STk. Then, the information processing apparatus 101 may identify the road corresponding to the location indicated by the positioning data D based on the calculated dissimilarity NR^{(k)}.

Thus, map matching using similarity search may be implemented. Identification of an unnatural travel route may be avoided by handling the location of the vehicle C as a point array but not as an individual point. For example, in a place where two roads run in parallel or in an intersection where roads intersect each other, identification of an unnatural travel route such as traveling by jumping to a different road may be avoided.

In a case where multiple road data is retrieved, the information processing apparatus 101 may identify a road indicated by road data corresponding to the latitude and longitude data array STk where the calculated dissimilarity NR^{(k)} is smallest, as a road corresponding to the location indicated by the positioning data D.

Thus, each of roads indicated by the road ID array of the road data corresponding to a latitude and longitude data array STk most similar with the positioning data D may be identified as a road corresponding to a measured point q indicated by the positioning data D.

The information processing apparatus 101 may be configured so as not to identify the road corresponding to the location indicated by the positioning data D in a case where the calculated dissimilarity NR^{(k)} is larger than the threshold α. Thus, in a case where there exists no latitude and longitude data array STk similar with the positioning data D, drop of map matching accuracy may be avoided by not identifying the road corresponding to the location indicated by the positioning data D.

The information processing apparatus 101 may output the measurement time of the location indicated by the positioning data D and the road corresponding to the identified location in association with each other. Specifically, for example, the information processing apparatus 101 may output map matching data representing the measurement time of each of the measured points q indicated by the positioning data D and the road ID of the road for the measured point q in association with each other.

Thus, it is possible to identify the time (measurement time) and the road where a vehicle C traveled and thereby recognize a road situation in real time.

The information processing apparatus 101 refers to the road data of an area A which includes the location indicated by the positioning data D among multiple areas A stored in the road data DB 1000. Thus, the information processing apparatus 101 may retrieve road data in which the location of a vehicle C indicated by the latitude and longitude data is included within range search area.

Thus, the area A including the location (for example, latest measured point q_{N}) of the vehicle C indicated by the positioning data D may be narrowed down, and thereby only a road data group related to the area A in the road data DB 1000 may be selected as a target to be searched. As a result, processing time and processing load for the retrieval of the road data may be reduced, and thereby the processing for map matching may be reduced.

The information processing apparatus 101 may accumulate pre-correction and post-correction location information, and identify the correspondence relationship between the zone and range search area by a statistical method, for each of arrangement patterns P of the multiple satellites S based on the accumulated pre-correction and post-correction location information.

Thus, the GPS error information map 800, in which a zone on the map and a range search area where a post-correction location obtained by the correction processing which removes an error from the measured location within the zone exists are associated with each other, may be generated for each of the arrangement patterns P of the multiple satellites S.

From the above, the information processing system 200 according to the embodiment may implement map matching having a real time property and accuracy based on the positioning data D obtained from a terminal device T mounted on a traveling vehicle C. Thus, the road situations at respective locations may be recognized in real time, and thereby a service providing traffic information immediately reflecting the road situations becomes possible. For example, real time traffic information may be provided to a bus company, a transportation company or a driver to facilitate recognition of the operation situation and organizing of the operation schedule.

Compared with the case where road situations are measured with sensors of the fixed type (for example, VICS) or the like on roads, the information processing system 200 may suppress equipment costs for leased lines, dedicated equipment, and so on and maintenance and management costs due to deterioration. Vehicle Information and Communication (VICS) is a registered trade mark.

In the above description, map matching for identifying a road where a vehicle C exists is described by using a vehicle C traveling on the ground as an example. However, the map matching is not limited thereto. For example, with a terminal device T mounted on a drone (unmanned aircraft) navigating in the air, map matching may be implemented to identify a flight route where a drone exists.

The information processing method described in the embodiment may be implemented by executing programs prepared in advance on a computer such as a personal computer and work station. The information processing programs are recorded in a computer readable recording medium such as a hard disk, flexible disk, CD-ROM, magneto-optical disk (MO), digital versatile disk (DVD), and universal serial bus (USB) memory, and are executed when a computer reads from the recording medium. The information processing programs may be distributed via a network such as internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing method comprising:
acquiring data indicating a first location measured with a satellite positioning system including a plurality of satellites;
identifying a second range corresponding to a first range including the first location based on first information and an arrangement pattern of the plurality of satellites at a time when the first location is measured, each of the first ranges being a range to which a location measured with the satellite positioning system corresponds, each of the second ranges being a range to which a corrected location obtained by correction processing to remove an error from the measured location corresponds, the first information indicating a correspondence relationship between each of the first ranges and each of the second ranges for each of arrangement patterns of the plurality of satellites; and
identifying a second location by correcting the first location based on the identified second range.

2. The information processing method according to claim 1, wherein
a sensor for the satellite positioning system is mounted on an object, and
the second location corresponds to a road where the object is located.

3. The information processing method according to claim 2, wherein
the road is identified based on the second location and road information indicating each location of each road.

4. The information processing method according to claim 1, wherein
the data indicates a time series variation of the first location.

5. The information processing method according to claim 2, further comprising:
outputting the road with associating with the first location.

6. An information processing apparatus comprising:
a memory; and
a processor coupled to the memory and configured to:
acquire data indicating a first location measured with a satellite positioning system including a plurality of satellites,
identify a second range corresponding to a first range including the first location based on first information and an arrangement pattern of the plurality of satellites at a time when the first location is measured, each of the first ranges being a range to which a location measured with the satellite positioning system corresponds, each of the second ranges being a range to which a corrected location obtained by correction processing to remove an error from the measured location corresponds, the first information indicating a correspondence relationship between each of the first ranges and each of the second ranges for each of arrangement patterns of the plurality of satellites, and
identify a second location by correcting the first location based on the identified second range.

7. The information processing apparatus according to claim 1, further comprising:
a sensor for the satellite positioning system,
wherein the second location corresponds to a road where the information processing apparatus is located.

8. A non-transitory computer readable storage medium that stores a program that causes an information processing apparatus to execute a process comprising:
acquiring data indicating a first location measured with a satellite positioning system including a plurality of satellites;
identifying a second range corresponding to a first range including the first location based on first information and an arrangement pattern of the plurality of satellites at a time when the first location is measured, each of the first ranges being a range to which a location measured with the satellite positioning system corresponds, each of the second ranges being a range to which a corrected location obtained by correction processing to remove an error from the measured location corresponds, the first information indicating a correspondence relationship between each of the first ranges and each of the second ranges for each of arrangement patterns of the plurality of satellites; and
identifying a second location by correcting the first location based on the identified second range.

9. The non-transitory computer readable storage medium according to claim 8, wherein
a sensor for the satellite positioning system is mounted on an object, and
the second location corresponds to a road where the object is located.
